(19) United States
(12) Patent Application Publication
(10) Pub. No.: US 2026/0002870 A1
(43) Pub. Date: Jan. 1, 2026

(54) Gas Absorption Spectroscopy System and Gas Absorption Spectroscopy Method

(71) Applicant: SHIMADZU CORPORATION, Kyoto-shi (JP)

(72) Inventors: Yuta KAWASHIMA, Kyoto-shi (JP); Kazune MANO, Kyoto-shi (JP)

(21) Appl. No.: 19/248,259

(22) Filed: Jun. 24, 2025

(30) Foreign Application Priority Data
Jun. 26, 2024 (JP) 2024-102597

(51) Int. Cl. G01N 21/39; G01N 21/31

(52) U.S. Cl. CPC G01N 21/39; G01N 21/3103; G01N 2201/0636

(57) ABSTRACT

A gas absorption spectroscopy system includes a resonator, a light source, a driver, a controller, and a detector. The resonator includes a first mirror and a second mirror. The light source irradiates the resonator with laser light. The driver varies a length between the first and second mirrors. The controller controls the driver. The detector outputs to the controller a detection signal corresponding to the detected light. The driver moves at least one of the first and second mirrors about a sweep center to change the length between the first and second mirrors, and, in response to the controller obtaining the detection signal, adjusts a length between the sweep center and the second mirror to be equal to a length present between the first and second mirrors at a time when the detection signal is obtained.

### CROSS REFERENCE TO RELATED APPLICATIONS

This nonprovisional application is based on Japanese Patent Application No. 2024-102597 filed on Jun. 26, 2024 with the Japan Patent Office the entire contents of which are hereby incorporated by reference.

### BACKGROUND OF THE INVENTION

### Field of the Invention

The present disclosure relates to a gas absorption spectroscopy system and a gas absorption spectroscopy method, and more particularly to improvement in measurement sensitivity for a target component in a gas enclosed in a cell.

### Description of the Background Art

Cavity ring-down absorption spectroscopy (CRDS) is known as a type of gas absorption spectroscopy. CRDS is a measurement method using a resonator (a cavity) including a mirror of high reflectance to increase an effective optical path length for absorption of light by a gas to determine a concentration of a target component contained in the gas with high sensitivity. Information for a gas absorption spectrometer using CRDS is disclosed for example in “A survey on techniques for high-efficiency measurement of trace moisture in gases”, Koji HASHIGUCHI, Advanced Industrial Science and Technology (AIST) bulletin of metrology, Vol. 9, No. 2, October 2015, and “Development of a low-temperature cavity ring-down spectrometer for the detection of Carbon-14”, A. D. McCartt, Stanford University, July 2014.

In CRDS, a ring-down signal obtained when a resonator is in resonance can be used to measure a concentration of a target component in a gas enclosed in a cell. Measuring the target component in the gas with higher sensitivity requires detecting and integrating a plurality of ring-down signals.

A known method for adjusting a resonator in length so that the resonator achieves resonance fixes a laser in frequency and sweeps a mirror of the resonator in a triangular waveform, for example as disclosed in “Mid-infrared continuous wave cavity ring-down spectroscopy of a pulsed hydrocarbon plasma”, Dongfeng Zhao, Joseph Guss, Anton J. Walsh, and Harold Linnartz, Chemical Physics Letters, Volume 565, 132-137, 2013 and “CRDS Measurement Data Acquisition in Supersonic Expansion”, M. Masat and O. Votava, WDS '11 Proceedings of Contributed Papers, Part II, 204-207, 2011. In this method, the resonator varies in length in the triangular waveform as time elapses, and a ring-down signal can be obtained when the resonator has a length that satisfies a predetermined condition.

In CRDS, measurement sensitivity can be enhanced by increasing a time for which resonance is achieved per unit time. For a method for maintaining resonance to increase a time for which resonance is achieved per unit time, “Spectroscopic detection of radiocarbon dioxide at parts-per-quadrillion sensitivity”, Iacopo Galli, Saverio Bartalini, Riccardo Ballerini, Marco Barucci, Pablo Cancio, Marco De Pas, Giovanni Giusfredi, Davide Mazzotti, Naota Akikusa, and Paolo De Natale, Optica 3, 385-388, 2016 discloses the Pound Driver Hall (PDH) method, in which a laser is controlled in frequency based on light initially reflected by a mirror located on a side on which the laser is incident.

### SUMMARY OF THE INVENTION

By using the PDH method disclosed in “Spectroscopic detection of radiocarbon dioxide at parts-per-quadrillion sensitivity”, Iacopo Galli, Saverio Bartalini, Riccardo Ballerini, Marco Barucci, Pablo Cancio, Marco De Pas, Giovanni Giusfredi, Davide Mazzotti, Naota Akikusa, and Paolo De Natale, Optica 3, 385-388, 2016, a time for which resonance is achieved per unit time can be increased and measurement sensitivity can be enhanced. The PDH method, however, requires not only a detector for detecting a ring-down signal but also a detector for detecting light initially reflected by the mirror located on the side on which the laser is incident, and the method may increase a cost for introducing a gas absorption spectrometer.

The present disclosure has been made in view of such circumstances and contemplates a gas absorption spectroscopy system for measuring a component of a gas through CRDS with enhanced measurement sensitivity for a component contained in a gaseous sample without an increased cost for introducing the system.

In a first aspect of the present disclosure a gas absorption spectroscopy system is a system configured to measure a target component in a gas enclosed in a cell. The gas absorption spectroscopy system comprises: a resonator including a first mirror and a second mirror disposed in the cell to reflect light therebetween; a light source configured to irradiate the resonator with laser light; a driver configured to vary a length between the first and second mirrors; a controller configured to control the driver; and a detector configured to detect light extracted from the resonator and output to the controller a detection signal corresponding to the detected light. The driver is configured to: move at least one of the first and second mirrors about a sweep center to change the length between the first and second mirrors; and, in response to the controller obtaining the detection signal, adjust a length between the sweep center and the second mirror to be equal to a length present between the first and second mirrors at a time when the detection signal is obtained.

In a second aspect of the present disclosure, a gas absorption spectroscopy method is a method using a resonator for measuring a target component contained in a gas enclosed in a cell. The resonator includes a first mirror and a second mirror disposed in the cell to reflect light therebetween. The gas absorption spectroscopy method comprises: irradiating the resonator with laser light emitted from a light source; moving at least one of the first and second mirrors about a sweep center to change a length between the first and second mirrors; obtaining a detection signal from the resonator; and, in response to obtaining the detection signal, adjusting a length between the sweep center and the second mirror to be equal to a length present between the first and second mirrors at a time when the detection signal is obtained.

The foregoing and other objects, features, aspects, and advantages of the present invention will become apparent from the following detailed description of the present invention when taken in conjunction with the accompanying drawings.

### BRIEF DESCRIPTION OF THE DRAWINGS

FIG. 1 schematically shows a configuration of a gas absorption spectroscopy system.

FIG. 2 is a diagram for illustrating a mode frequency.

FIG. 3 is a diagram for illustrating a method for adjusting a resonator length so as to achieve resonance according to a comparative example.

FIG. 4 is a diagram for illustrating a method for obtaining a ring-down signal according to a comparative example.

FIG. 5 is a diagram for illustrating sweeping of an actuator according to a first embodiment.

FIG. 6 is a diagram for illustrating a method for obtaining a ring-down signal according to the first embodiment.

FIG. 7 is a diagram for illustrating how many ring-down signals can be obtained per unit time.

FIG. 8 is a flowchart of gas absorption spectrometry according to the first embodiment.

FIG. 9 is a block diagram schematically, generally showing a configuration of a gas absorption spectroscopy system according to a second embodiment.

### DESCRIPTION OF THE PREFERRED EMBODIMENTS

Hereinafter, an embodiment of the present disclosure will be described in detail with reference to the drawings. In the figures, identical or equivalent components are identically denoted and will not be described repeatedly.

### [Configuration of Apparatus]

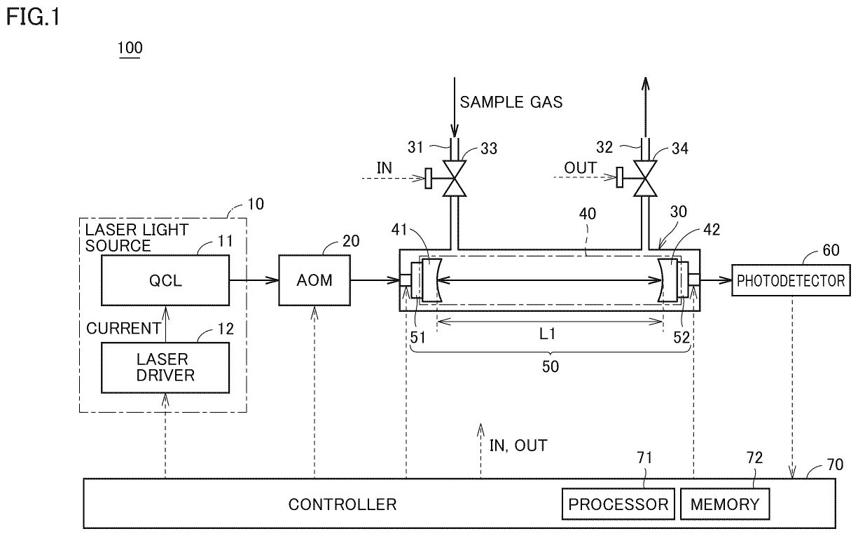

FIG. 1 is a block diagram schematically, generally showing a configuration of a gas absorption spectroscopy system according to a first embodiment of the present disclosure. Referring to FIG. 1, a gas absorption spectroscopy system 100 is a spectroscopy system that employs cavity ring-down absorption spectroscopy (CRDS) to measure absorption of light by a target component contained in a gas (a sample gas) to be measured.

Gas absorption spectroscopy system 100 comprises a laser light source 10, an acoustic-optical modulator (AOM) 20, a cell 30, a resonator 40, a mirror driver 50, a photodetector 60, and a controller 70.

Laser light source 10 irradiates resonator 40 with laser light. Laser light source 10 is configured to be capable of varying the laser light's oscillation frequency in response to a command received from controller 70. Specifically, laser light source 10 includes a distributed-feedback quantum cascade laser (QCL) 11 and a laser driver 12. QCL 11 emits laser light having a center oscillation frequency for example of about 2200 cm⁻¹ (with a wavelength of about 4.5 μm). Laser driver 12 supplies a drive current to QCL 11 in response to a command received from controller 70. The drive current to QCL 11 can be varied to sweep the oscillation frequency of QCL 11 by about 0.2 cm⁻¹.

AOM 20 is provided on an optical path between laser light source 10 and resonator 40. AOM 20 is an optical switch (a switch) that operates in response to a command received from controller 70 to rapidly switch emission to interruption and vice versa of laser light emitted from laser light source 10 to resonator 40. When AOM 20 receives an on command from controller 70 to emit light, the AOM is turned on to output to resonator 40 laser light received from laser light source 10. When AOM 20 receives an off command from controller 70 to interrupt light, the AOM is turned off to avoid outputting to resonator 40 laser light received from laser light source 10.

Cell 30 is a chamber capable of sealing a sample gas, and for example has a cylindrical shape. To cell 30 are connected an introduction pipe 31 for introducing the sample gas before a measurement starts and a discharge pipe 32 for discharging the sample gas after the measurement ends. Introduction pipe 31 is provided with an introduction valve 33. Discharge pipe 32 is provided with a discharge valve 34. Introduction valve 33 and discharge valve 34 can be opened/closed as controlled by controller 70.

Resonator 40 is provided between AOM 20 and photodetector 60. In the first embodiment, resonator 40 is a Fabry-Perot optical resonator. A pair of mirrors 41 and 42 are provided in resonator 40. Mirrors 41 and 42 are disposed in resonator 40 to be opposed to each other to reflect light therebetween. Mirrors 41 and 42 each have a concave surface to help satisfying a condition to stabilize resonator 40. Furthermore, mirrors 41 and 42 are each of a high reflectance (e.g., of about 99.9%) to extremely weaken light leaking out of resonator 40. Resonator 40 has a resonator length (or a distance between mirrors 41 and 42 along an optical axis) for example of about 450 mm. Resonator 40 may not have two mirrors disposed therein, and may instead have three or more mirrors disposed therein. That is, the resonator may have mirrors disposed to reflect light therebetween or may have mirrors disposed in the form of a ring to reflect light in one direction.

In the first embodiment, resonator 40 has a resonator length that is a distance between mirrors 41 and 42 in a direction interconnecting mirrors 41 and 42 (or along the optical axis). Hereinafter, this resonator length will be represented by L1. The resonator length L1 is for example 30 cm.

In the example shown in FIG. 1, mirrors 41 and 42 are both concave mirrors. However, mirrors 41 and 42 may not both be concave mirrors. At least one of mirrors 41 and 42 may be a concave mirror. For example, one of mirrors 41 and 42 may be a concave mirror, and the other may be a plane mirror.

Mirror driver 50 drives mirrors 41 and 42 that constitute resonator 40 in response to a command received from controller 70. In the present embodiment, mirror driver 50 includes a pair of actuators provided so as to correspond to the pair of mirrors 41 and 42. Each actuator is a piezo element (a piezoelectric element) having a doughnut-shaped hole to pass light therethrough. Piezo element 51 moves mirror 41 along the optical axis. Similarly, piezo element 52 moves mirror 42 along the optical axis.

Linearly varying a voltage applied to piezo element 51 linearly moves mirror 41. Therefore, in order to sweep mirror 41 in a triangular waveform, a voltage in the triangular waveform may be applied to piezo element 51. Piezo element 52 is similarly discussed. Piezo elements 51 and 52 are controlled, as will be described hereinafter in detail.

Photodetector 60 is a photodiode, an image sensor or a similar photodetector. Photodetector 60 detects weak light that is extracted from mirror 42 of resonator 40 as light output from resonator 40, and the photodetector outputs to controller 70 a signal indicating a result of the detection (or a detection signal). For photodetector 60, a liquid nitrogen cooled InSb (indium antimony) detector and an MCT detector can be employed, for example.

Controller 70 includes a processor 71 such as a central processing unit (CPU) or a field-programmable gate array (FPGA), a memory 72 such as read only memory (ROM) and random access memory (RAM), and an input/output port (not shown).

Controller 70 controls each device that constitutes gas absorption spectroscopy system 100. Specifically, controller 70 outputs a command to laser driver 12 to scan laser light's oscillation frequency, outputs the above-described on or off signal to AOM 20, and so on. Controller 70 outputs a command to introduction valve 33 to introduce a sample gas into resonator 40, outputs a command to discharge valve 34 to discharge the sample gas out of resonator 40, and so on. Controller 70 applies voltage to piezo elements 51 and 52 to move mirrors 41 and 42. Furthermore, controller 70 uses the detection signal received from photodetector 60 to perform a variety of types of data processing to calculate a concentration (an absolute concentration) of a target component contained in the sample gas.

Controller 70 may be divided into two or more units for each function and thus configured. For example, controller 70 may be divided into a unit that controls each device and a unit that performs the variety of types of data processing.

### [Principle of Measurement by Cavity Ring-Down Absorption Spectroscopy (CRDS)]

Hereinafter will briefly be described a principle of measurement by cavity ring-down absorption spectroscopy in gas absorption spectroscopy system 100. In general, resonance occurs when radiated laser light's frequency and a resonator's length satisfy a resonance condition. Hereinafter, a frequency of laser light with which resonator 40 is irradiated will be referred to as a “laser frequency”, and a frequency of laser light at which resonator 40 can produce resonance will be referred to as a “mode frequency”.

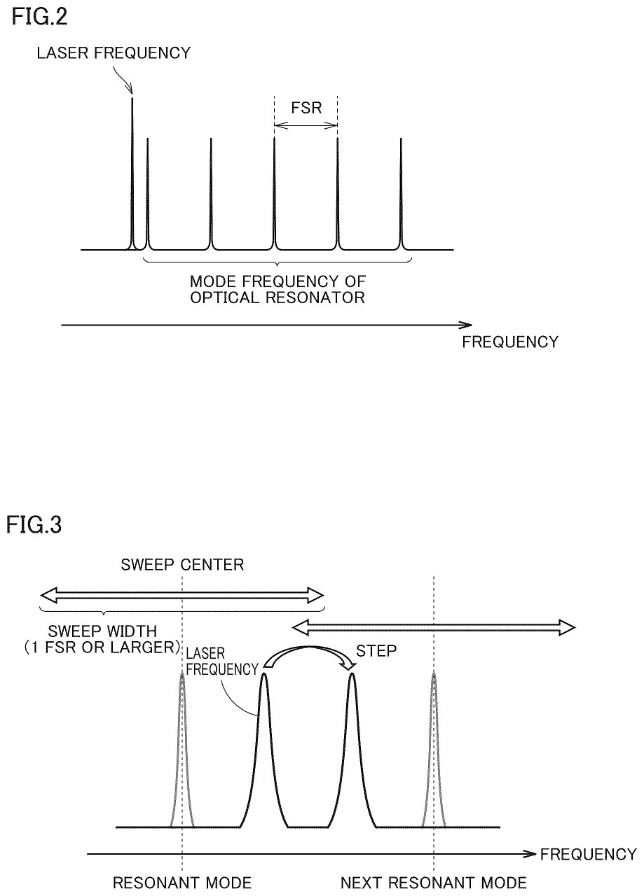

FIG. 2 is a diagram representing a concept for illustrating a mode frequency. As shown in FIG. 2, a plurality of mode frequencies exist at predetermined frequency intervals. Hereinafter, an interval between two adjacent ones of the plurality of mode frequencies will be referred to as a “free spectral range (FSR)”.

The resonance condition is that twice the length L of the resonator is an integral multiple of a wavelength λ of laser light. Therefore, resonator 40 achieves resonance when the following equation (1) is satisfied.

$$2 L = q λ , \qquad ( 1 )$$

where q is an integer.

Herein, the laser light has the wavelength λ and a laser frequency ν in a relationship expressed by the following equation (2) using speed of light c:

$$c = λ v . \qquad ( 2 )$$

Therefore, from equations (1) and (2), the resonance condition is represented by the following equation (3):

$$v = qc / 2 L . \qquad ( 3 )$$

There are a plurality of ν satisfying this condition, and each frequency is a mode frequency of the resonator. Furthermore, from equation (3), an interval between two adjacent ones of the plurality of mode frequencies, or FSR, is represented by c/2L.

When the laser frequency does not match any of the mode frequencies, resonator 40 does not store power of light. In contrast, when the laser frequency matches any one of the mode frequencies, resonator 40 stores power of light.

From a signal output from photodetector 60 (or light output from resonator 40), controller 70 determines whether the laser light's power is sufficiently accumulated in resonator 40. When resonator 40 outputs light having a predetermined threshold value, controller 70 determines that resonator 40 has the laser light's power sufficiently accumulated therein, and the controller outputs the off signal to AOM 20. AOM 20 interrupts light input to resonator 40. Then, the light stored in resonator 40 reciprocates between mirrors 41 and 42 a large number of times (normally, several thousands to several tens of thousands times). As the light reciprocates between mirrors 41 and 42, the light gradually attenuates due to a loss caused by leakage of reflection by mirrors 41 and 42 and absorption by the target component in the sample gas. Therefore, light output from resonator 40 leaking from mirror 42 gradually attenuates. In CRDS, by using resonator 40 to increase a distance for which light passes through a sample gas (i.e., an effective optical path length), absorption of light by a target component can be detected even if it is extremely small absorption.

After AOM 20 interrupts light input to resonator 40, controller 70 obtains a signal output from photodetector 60 as a “ring-down signal”, and calculates an attenuation time constant of the obtained ring-down signal as a “ring-down time”. Controller 70 uses the calculated ring-down time to calculate the concentration of the target component contained in the sample gas.

Controller 70 obtains the signal that is output from photodetector 60 at intervals for example of 0.2 μsec, and the controller calculates a ring-down time from the signal output and thus obtained from photodetector 60. When there is no component of a gas in resonator 40 that absorbs laser light, the ring-down time will be an attenuation time constant by resonator 40 and hence substantially be a constant value. In contrast, when a component of a gas that absorbs laser light is present in resonator 40, the ring-down time will have a value varying with the concentration of the component of the gas. This can be exploited to quantify the target component's concentration.

### Comparative Example

In CRDS, after resonator 40 accumulates light (laser light) therein, AOM 20 interrupts light input to resonator 40, and photodetector 60 measures attenuation of light leaking from resonator 40 after the AOM interrupts light. The measurement data is used to determine a time constant of attenuation of light (or a ring-down time) to measure a concentration of a target component contained in a gas in resonator 40.

An analysis of an isotopic molecule can be conducted through CRDS by exploiting the fact that an isotope constituting a molecule absorbs infrared light of a different wavelength. For example, among isotopes of carbon, the only long half-life radionuclide, or a radioactive isotope of carbon ¹⁴C, is used as an environmental tracer. By measuring an abundance ratio of ¹⁴C in an organic resource, whether the organic resource is derived from plant-derived biomass or fossil fuel can be determined. Furthermore, ¹⁴C is also used as a biological tracer. In developing pharmaceuticals, a compound in which a portion of carbon of the compound is labeled with ¹⁴C can be administered to a living body to measure a concentration of ¹⁴C accumulated in the blood, urine, feces, and organs of the living body to analyze the administered compound's in vivo kinetics. However, ¹⁴C has a very small isotopic ratio. Therefore, measuring ¹⁴C requires distinguishing ¹⁴C from other isotopes of carbon to detect ¹⁴C with high sensitivity. Thus, there is a need for enhanced sensitivity in CRDS for measuring a component contained in a gaseous sample.

In CRDS, a ring-down signal obtained when resonator 40 is in resonance is used to derive a concentration of a target component in a gas. Resonator 40 achieves resonance when emitted laser's frequency and the resonator length L1 satisfy a resonance condition. Measuring the target component in the gas with higher sensitivity requires detecting and integrating a plurality of ring-down signals.

If the resonator length L1 is slightly different from the length that allows resonance, the ring-down signal cannot be obtained. For example, when the resonator length L1 is varied due to variation in temperature during measurement, resonator 40 is no longer in resonance. Therefore, even when a laser frequency is fixed, it is necessary to continue to adjust the resonator length L1 during measurement through CRDS to maintain resonance.

A known method for adjusting the resonator length L1 so that resonator 40 achieves resonance sweeps mirror 41 of resonator 40 in a triangular waveform, for example as disclosed in “Mid-infrared continuous wave cavity ring-down spectroscopy of a pulsed hydrocarbon plasma”, Dongfeng Zhao, Joseph Guss, Anton J. Walsh, and Harold Linnartz, Chemical Physics Letters, Volume 565, 132-137, 2013, and “CRDS Measurement Data Acquisition in Supersonic Expansion”, M. Masat and O. Votava, WDS '11 Proceedings of Contributed Papers, Part II, 204-207, 2011. According to this method, the resonator length L1 varies in the triangular waveform, and a ring-down signal can be obtained at a timing when the resonator length L1 satisfies a predetermined condition.

FIG. 3 is a diagram for illustrating a method for adjusting the resonator length L1 according to a comparative example. When the equation (3) is arranged for the resonator length L, it will be the following equation (4):

$$L = qc / 2 v . \qquad ( 4 )$$

Therefore, when the laser frequency vis fixed, by varying at least the resonator length L1 by a length corresponding to 1 FSR, i.e., c/2v, or more, there is a position of mirror 41 at least once while the mirror is swept, that allows resonance.

As shown in FIG. 3, in the adjustment method according to the comparative example, mirror 41 is swept at a fixed frequency with a width equal to or larger than a length corresponding to 1 FSR. By doing so, there is a position of mirror 41 at least once while it is swept, that allows resonance. Sweeping mirror 41 as described above allows resonance to be achieved in one or more resonant modes at any laser frequency, and even if a condition under which resonance is achieved is changed during measurement, a ring-down signal can be obtained at least once while mirror 41 is swept.

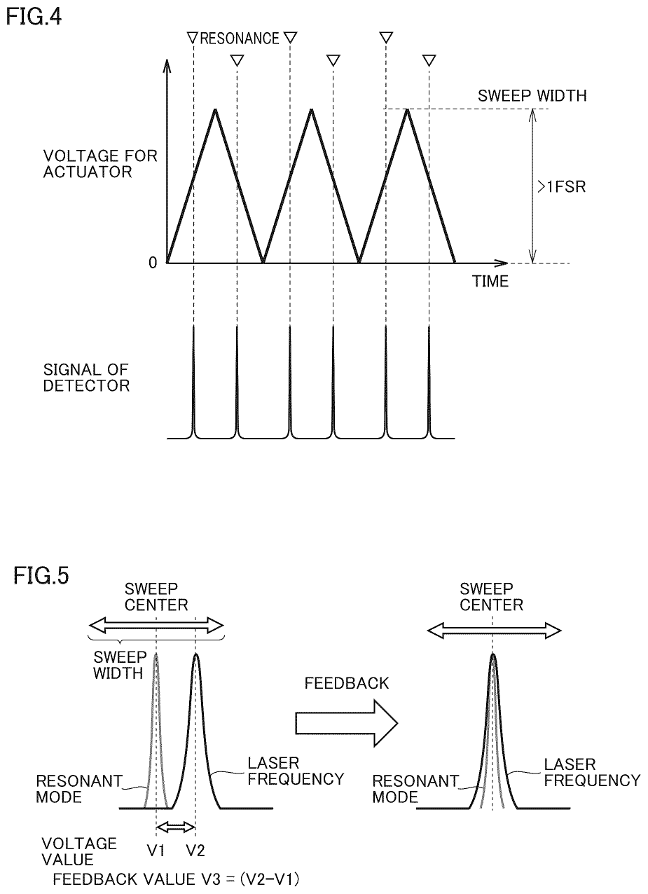

FIG. 4 is a diagram for illustrating a timing of obtaining a ring-down signal according to a comparative example. As shown in FIG. 4, sweeping mirror 41 with a width equal to or larger than the length corresponding to 1 FSR allows a ring-down signal to be obtained whatever laser frequency may be applied.

In the above-described method for adjusting the resonator length L1, there may be a laser frequency which does not enable resonance for a sweep width set to be smaller than the length corresponding to 1 FSR, and accordingly, it is necessary to sweep mirror 41 with a width equal to or larger than the length corresponding to 1 FSR. Thus, the mirror is not swept with a reduced width, and this limits the number of ring-down signals that can be obtained per unit time.

A method for improving a ring-down signal that can be obtained per unit time is the PDH method, as indicated in “Spectroscopic detection of radiocarbon dioxide at parts-per-quadrillion sensitivity”, Iacopo Galli, Saverio Bartalini, Riccardo Ballerini, Marco Barucci, Pablo Cancio, Marco De Pas, Giovanni Giusfredi, Davide Mazzotti, Naota Akikusa, and Paolo De Natale, Optica 3, 385-388, 2016. In the PDH method, light initially reflected by a mirror on the incident side is detected by a detector on a side on which laser is incident. The detected signal can be used to adjust the laser in frequency to maintain resonance.

The PDH method requires not only a detector for detecting a ring-down signal but also a detector for detecting light initially reflected by the mirror on the side on which the laser is incident, and this may increase a cost for introducing a gas absorption spectrometer. Therefore, there is a need for increasing a time for which resonance is achieved per unit time to enhance measurement sensitivity for a target component contained in a gaseous sample without increasing a cost associated with introducing a gas absorption spectroscopy system.

### [Gas Absorption Spectroscopy System According to the Present Disclosure]

Accordingly, gas absorption spectroscopy system 100 according to the first embodiment, in response to controller 70 obtaining the ring-down signal, moves mirror 42 so that a length between a center for sweeping mirror 41 and mirror 42 is equal to a length present between mirrors 41 and 42 when a ring-down signal is obtained. The length between the center for sweeping mirror 41 and mirror 42 is thus equal to the resonator length corresponding to the immediately previously achieved resonance. This allows a reduced sweep width and hence an increased time for which resonance is achieved per unit time.

Specifically, in the first embodiment, a sweep width may be a width corresponding to a difference between a resonator length corresponding at least to the immediately previously achieved resonance and a resonator length corresponding to resonance varied as a measurement condition (such as temperature) varies during sweeping. This difference is generally smaller than the length corresponding to 1 FSR.

Gas absorption spectroscopy system 100 of the first embodiment thus allows a reduced sweep width, a higher sweeping frequency, and an increased number of ring-down signal that can be obtained per unit time. This in turn enables CRDS with enhanced measurement sensitivity for a component contained in a gaseous sample.

Furthermore, in contrast to the PDH method, the first embodiment dispenses with the photodetector on the side on which laser is incident. This allows CRDS measurement sensitivity to be enhanced without increasing a cost for introducing a gas absorption spectrometer.

Gas absorption spectroscopy system 100 obtains a ring-down signal in a method, as will be described below.

### <Determining Initial Sweep Center>

Gas absorption spectroscopy system 100 initially determines a position that serves as an initial center for sweeping mirror 41. The position serving as the initial sweep center may be predetermined according to a type of a target component in a sample gas, or may be determined in response to a ring-down signal being obtained as mirror 41 and/or mirror 42 are/is displaced.

Hereinafter will be described an example in which mirror 41 is displaced and a position for which a ring-down signal is initially obtained is set as an initial center for sweeping mirror 41.

While cell 30 is filled with a sample gas to be measured, gas absorption spectroscopy system 100 controls laser driver 12 so as to irradiate the sample gas with laser light having the laser frequency v.

Controller 70 times AOM 20, as predetermined, to interrupt laser light. Subsequently, controller 70 applies voltage to piezo element 51 to move mirror 41.

Mirror 41 is moved and when the laser frequency ν matches a resonance condition of resonator 40, photodetector 60 obtains a ring-down signal. Controller 70 obtains a voltage value V1 applied to piezo element 51 when the laser frequency ν matches the resonance condition of resonator 40. Gas absorption spectroscopy system 100 determines the position of mirror 41 at that time as the initial center for sweeping mirror 41.

### <Controlling Mirror 42 Through Feedback>

Subsequently, gas absorption spectroscopy system 100 sweeps mirror 41, and moves mirror 42 in response to a ring-down signal being obtained. FIG. 5 is a diagram for describing that mirror 42 is controlled through feedback when gas absorption spectroscopy system 100 obtains a ring-down signal according to the first embodiment.

Controller 70 applies voltage to piezo element 51 in a triangular waveform about the initial center for sweeping mirror 41 to sweep mirror 41 in the triangular waveform. Mirror 41 may be swept with a width smaller than the length corresponding to 1 FSR, and it is for example a length corresponding to 0.01 FSR. Furthermore, mirror 41 is swept at 100 to 500 Hz.

When a ring-down signal is obtained while mirror 41 is swept, controller 70 obtains a voltage value V2 applied to piezo element 51 when the ring-down signal is obtained.

A difference between the center for sweeping mirror 41 and the position that mirror 41 assumes when the ring-down signal is obtained corresponds to a difference between the voltage value V1 and the voltage value V2, or a voltage value V3. The voltage value V3 is applied to piezo element 52 to move mirror 42.

Applying the voltage value V3 to piezo element 52 to move mirror 42, that is, applying feedback control, resets the center for sweeping mirror 41. A length between the reset center for sweeping mirror 41 and mirror 42 matches a length present between mirrors 41 and 42 when resonance was immediately previously achieved.

Controller 70 continues to sweep mirror 41 and control mirror 42 through feedback until scanning at the laser frequency ν is completed. The scanning at the laser frequency ν is completed for example when a predetermined number of ring-down signals are obtained and when a predetermined period of time has elapsed since measurement was started.

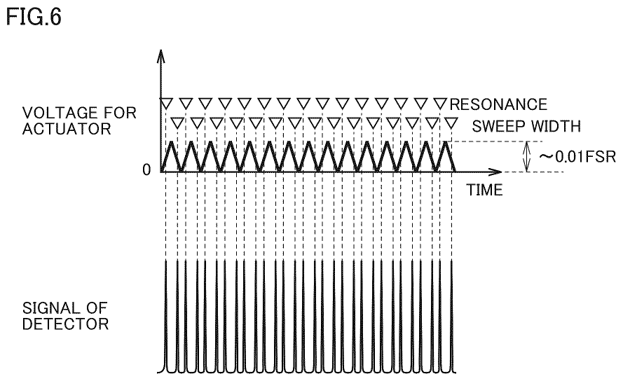

FIG. 6 is a diagram for illustrating a result of obtaining a ring-down signal according to the first embodiment. As shown in FIG. 6, by displacing mirror 42, the length between the center for sweeping mirror 41 and mirror 42 can be matched to the length present between mirrors 41 and 42 when resonance was immediately previously achieved. Accordingly, mirror 41 may be swept with a width corresponding to variation in a resonant frequency caused after a ring-down signal is obtained before a subsequent ring-down signal is obtained. As a result, as shown in FIG. 6, an increased number of ring-down signals can be detected by photodetector 60 per unit time.

As described above, adjusting the length between the center for sweeping mirror 41 and mirror 42 to be equal to the length present between mirrors 41 and 42 when resonance was immediately previously achieved is done for example by adjusting a value of voltage applied to piezo element 52.

Note that after the scanning at the laser frequency ν is completed, gas absorption spectroscopy system 100 varies the laser frequency and obtains a ring-down signal again. Spectral data obtained through measurement at a plurality of laser frequencies is used to calculate a concentration of a target component contained in the sample gas.

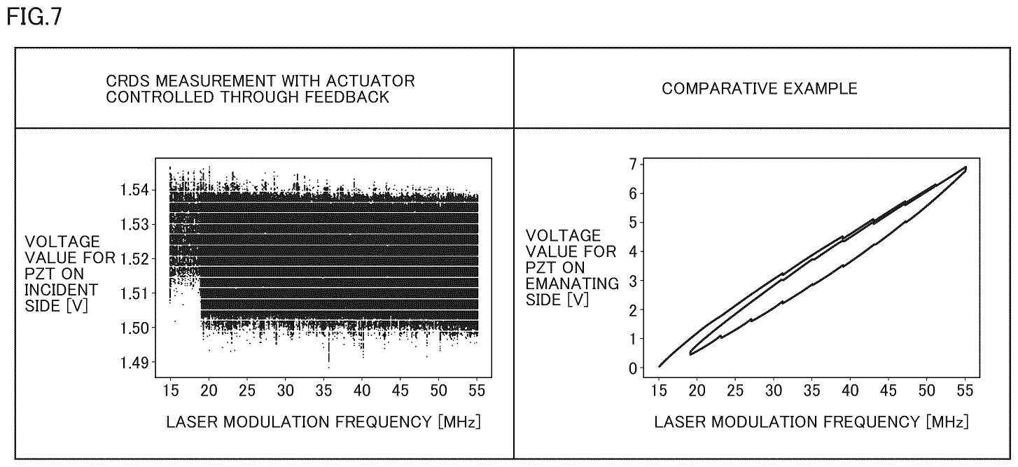

FIG. 7 is a diagram for illustrating how many ring-down signals can be obtained per unit time in measurement through CRDS. FIG. 7 plots timing of obtaining a ring-down signal. In FIG. 7, the axis of abscissas represents modulation frequency for laser, and the axis of ordinates represents a value of voltage applied to piezo element 51. FIG. 7 represents how many ring-down signals can be obtained per unit time in each of the method described in the first embodiment and a method described in a comparative example.

As shown in FIG. 7 as the comparative example, when mirror 41 is swept with a width equal to or larger than the length corresponding to 1 FSR, a voltage having a value of 5 V is applied to piezo element 51. In the first embodiment, a voltage having a value of 0.05 V is applied to piezo element 51. The first embodiment can provide a smaller sweep width than the comparative example. As a result, when the first embodiment is compared with the comparative example, the former allows mirror 41 to be swept faster (or reciprocated more frequently per unit time) than the latter and can obtain a number of ring-down signals per unit time that is approximately 100 times that of ring-down signals obtained by the latter.

### [Flowchart for Gas Absorption Spectrometry]

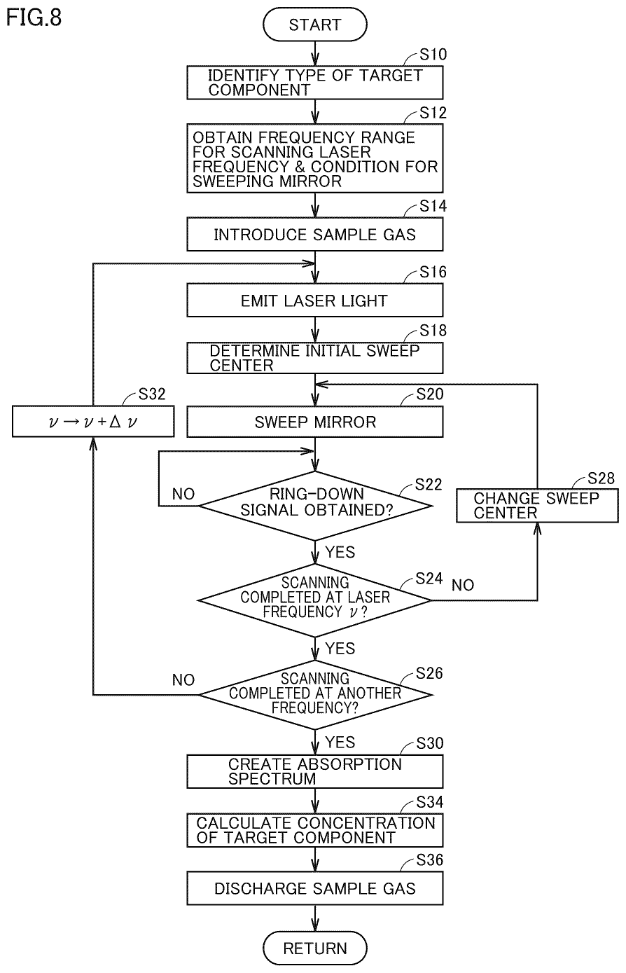

Hereinafter will be described a flow of a process for gas absorption spectrometry performed in controller 70. FIG. 8 is a flowchart of gas absorption spectrometry performed by controller 70. In one implementation, the FIG. 8 process is invoked from a main routine and performed when an application program for gas absorption spectrometry is started in controller 70. Note that, in the first embodiment, adjusting the length between the center for sweeping mirror 41 and mirror 42 to be equal to the length present between mirrors 41 and 42 when resonance was immediately previously achieved is done by adjusting a value of voltage applied to piezo element 52.

Referring to FIG. 8, in step S10, controller 70 receives information for identifying a type of a target component in a sample gas. For example, a person who measures the target component can input the type of the target component by operating an input device (not shown) such as a keyboard or a mouse.

Depending on the type of the target component in the sample gas, a frequency range for laser light used for measurement is predetermined in a vicinity of an absorption peak of the target component. Furthermore, a condition for scanning mirror 41 (a width and frequency for sweeping mirror 41) is determined for each type of target component. Such a predetermined measurement condition is stored in controller 70 at memory 72.

In step S12, controller 70 reads from memory 72 a frequency range corresponding to the target component for scanning laser light. Furthermore, controller 70 reads from memory 72 a condition for scanning mirrors 41 and 42 depending on the target component.

In step S14, controller 70 introduces the sample gas into cell 30 by opening introduction valve 33 while discharge valve 34 is closed. Cell 30 is internally provided with a pressure sensor (not shown) to measure internal pressure of cell 30. When the pressure sensor measures that the internal pressure reaches a predetermined value, controller 70 closes introduction valve 33. Cell 30 is thus filled with the sample gas.

In step S16, controller 70 sets an oscillation frequency (or a laser frequency) v for laser light in laser light source 10, and irradiates resonator 40 with the laser light. More specifically, a correspondence between the laser frequency ν and a drive current to QCL 11 that is required to oscillate QCL 11 at that laser frequency ν is obtained in advance. Controller 70 refers to this correspondence to output a command to laser driver 12 to output a drive current corresponding to the laser frequency ν as desired.

In step S18, controller 70 determines an initial center for sweeping mirror 41. The initial sweep center may be predetermined according to the type of the target component in the sample gas, or may be determined in response to a ring-down signal being obtained as mirror 41 and/or mirror 42 are/is displaced.

In step S20, controller 70 sweeps mirror 41 about the determined sweep center with the sweep width and frequency read in step S12. While the mirror is swept, controller 70 times AOM 20, as predetermined, to interrupt laser light. Controller 70 obtains the voltage value V1 applied to piezo element 51 when mirror 41 is located at the sweep center.

In step S22, controller 70 confirms whether photodetector 60 obtains a ring-down signal. When controller 70 determines that photodetector 60 obtains a ring-down signal (YES in step S20), the controller obtains the voltage value V2 applied to piezo element 51 when the ring-down signal is obtained, and the controller proceeds to step S22; otherwise (No in step S20), repeats step S22.

In step S24, controller 70 determines whether scanning at the laser frequency ν is completed. Whether scanning at the laser frequency ν is completed is determined for example by a number of ring-down signals obtained and a period of time having elapsed since sweeping was started. If scanning at laser frequency ν is completed (YES in step S24), controller 70 proceeds to step S26, otherwise (NO in step S24), controller 70 proceeds to step S28.

In step S26, controller 70 determines whether scanning at another laser frequency is completed. If scanning at the other laser frequency is completed (YES in step S26), controller 70 proceeds to step S30, otherwise (NO in step S26), controller 70 proceeds to step S32.

In step S28, controller 70 moves mirror 42 to change the sweep center so that the length between the center for sweeping mirror 41 and mirror 42 is a resonator length that allowed resonance. Specifically, controller 70 applies a difference between the voltage value V1 and the voltage value V2, or the voltage value V3, to piezo element 52 to move mirror 42. Subsequently, controller 70 returns to step S20.

In step S30, based on the ring-down signal measured in step S20 for each laser frequency v, controller 70 calculates a ring-down time t for the sample gas for the laser frequency ν to create an absorption spectrum for the sample gas.

In step S32, controller 70 increments the laser frequency ν by a predetermined scanning width Δν, and returns to step S16. The manner of scanning the laser frequency ν is not particularly limited. The laser frequency may be decremented, rather than incremented, and the scanning width Δν may not be a fixed width.

In step S34, controller 70 calculates an absolute concentration (or a number density N) of the target component in the sample gas. For example, the absorption spectrum can be subjected to curve fitting to determine a peak frequency, and the number density N can be calculated from an absorption coefficient α at the peak frequency.

In step S36, controller 70 opens discharge valve 34, and discharges the sample gas in cell 30 using a vacuum pump (not shown) provided downstream of discharge valve 34. This completes a series of steps of the process. Subsequently, controller 70 returns to the main routine.

In the first embodiment, in response to a ring-down signal being obtained, the length between the center for sweeping mirror 41 and mirror 42 is adjusted to match a condition under which resonance is achieved. This allows mirror 41 to be swept with a reduced width faster and can increase a number of ring-down signals that can be obtained per unit time. This allows CRDS measurement to be done with enhanced measurement sensitivity.

Furthermore, according to the first embodiment, a number of ring-down signals that can be obtained per unit time can be increased without using a photodetector provided on a side on which laser is incident. This allows CRDS measurement sensitivity to be enhanced without increasing a cost for introducing a gas absorption spectrometer.

Note that while in the first embodiment mirror 42 is controlled through feedback in response to controller 70 obtaining a ring-down signal, mirror 41 may be controlled through feedback. In that case, gas absorption spectroscopy system 100 may dispense with piezo element 52. Controller 70 controls piezo element 51 in two manners, that is, controls the piezo element to sweep mirror 41 in a triangular waveform and controls the piezo element through feedback to match a sweep center to a position allowing resonance.

Furthermore, while in the first embodiment mirror 42 is controlled through feedback whenever controller 70 obtains a ring-down signal, a timing of controlling the mirror through feedback is not limited thereto. For example, after a ring-down signal is obtained 10 times, a deviation between a position of mirror 41 and a center for sweeping the mirror at a timing when a ring-down signal is obtained may be added together with other such deviations, and mirror 42 may be controlled through feedback at a timing when a ring-down signal is obtained for the 10th time.

### Second Embodiment

In the first embodiment has been described a configuration using resonator 40 that is a Fabry-Perot resonator including two mirrors 41 and 42. In a second embodiment will be described a configuration employing a ring-type optical resonator including three mirrors.

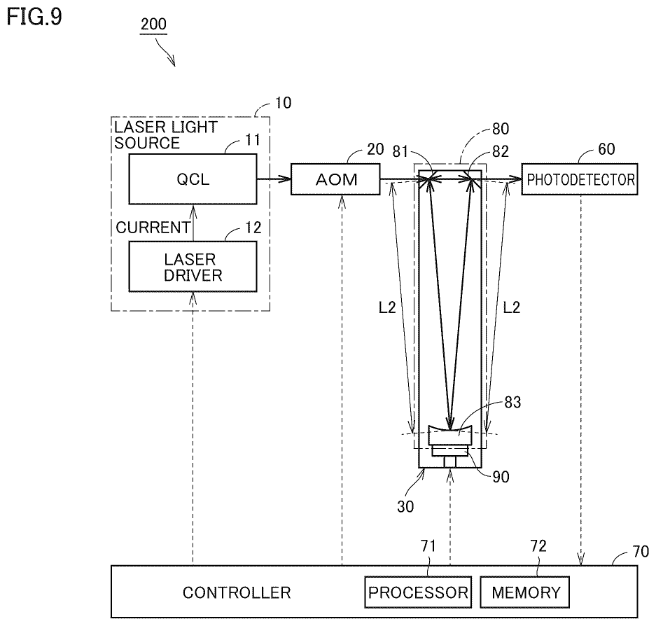

FIG. 9 is a block diagram schematically, generally showing a configuration of a gas absorption spectroscopy system 200 according to the second embodiment. Referring to FIG. 9, gas absorption spectroscopy system 200 differs from gas absorption spectroscopy system 100 (see FIG. 1) according to the first embodiment in that the former comprises a resonator 80 rather than resonator 40. FIG. 9 does not show a mechanism provided in cell 30 for introducing/discharging a sample gas for the sake of simplicity for the figure.

Resonator 80 includes three mirrors 81 to 83 disposed in cell 30. Laser light emitted to resonator 80 repeats reflection sequentially in an order of mirror 81-mirror 82-mirror 83-mirror 81-mirror 82-mirror 83 . . . . Mirrors 81 and 82 are plane mirrors. Mirror 83 is a concave mirror. A distance between mirrors 81 and 82 is equal to a distance between mirrors 83 and 82. This distance will be referred to as a “resonator length L2”.

Mirror 83 is provided with a piezo element 90. Piezo element 90 moves mirror 83 in response to a command received from controller 70. This can vary the resonator length L2. Piezo element 90 is not provided with a doughnut-shaped hole.

The remainder in configuration of gas absorption spectroscopy system 200 is equivalent to a configuration of gas absorption spectroscopy system 100 according to the first embodiment that corresponds thereto. The second embodiment also employs a gas absorption spectroscopy method equivalent to the method in the first embodiment (see FIG. 8). Therefore, it is not described repeatedly in detail.

Mirror 81 corresponds to a “first mirror” according to the present disclosure. Mirror 82 corresponds to a “third mirror” according to the present disclosure. Mirror 83 corresponds to a “second mirror” according to the present disclosure.

In the second embodiment as well, piezo element 90 provided for mirror 83 is controlled to sweep mirror 83 and also adjust the resonator length L2 in response to controller 70 obtaining a ring-down signal to allow a center for sweeping mirror 83 to allow resonance. Thus, as well as in the first embodiment, mirror 83 sweeps about a center that is a position allowing resonance and the mirror can thus be swept more frequently to obtain an increased number of ring-down signals per unit time. The second embodiment also allows a gas absorption spectroscopy system for measuring a component of a gas through CRDS to measure a component contained in a gaseous sample with enhanced sensitivity without increasing a cost for introducing the system.

### [Aspects]

It will be understood by those skilled in the art that the exemplary embodiments described above are specific examples of the following aspects.

(Clause 1) In one aspect a gas absorption spectroscopy system is a gas absorption spectroscopy system for measuring a target component in a gas enclosed in a cell, the gas absorption spectroscopy system comprising: a resonator including a first mirror and a second mirror disposed in the cell to reflect light therebetween; a light source configured to irradiate the resonator with laser light; a driver configured to vary a length between the first and second mirrors; a controller configured to control the driver; and a detector configured to detect light extracted from the resonator and output to the controller a detection signal corresponding to the detected light, wherein the driver may be configured to: move at least one of the first and second mirrors about a sweep center to change the length between the first and second mirrors; and, in response to the controller obtaining the detection signal, adjust a length between the sweep center and the second mirror to be equal to a length present between the first and second mirrors at a time when the detection signal is obtained.

The gas absorption spectroscopy system according to clause 1 that is a gas absorption spectroscopy system for measuring a component of a gas can measure a component contained in a gaseous sample with enhanced sensitivity without increasing a cost for introducing the system.

(Clause 2) In the gas absorption spectroscopy system according to clause 1, the detection signal may be detected by the detector when a frequency of the laser light matches a resonant frequency of the resonator.

The gas absorption spectroscopy system according to clause 2 adjusts a length between the center for sweeping the first mirror and the second mirror based on a ring-down signal obtained when the laser light's frequency matches the resonator's frequency.

(Clause 3) In the gas absorption spectroscopy system according to clause 1 or 2, the second mirror may be configured to be moveable, and the driver may be configured to move the second mirror to adjust the length between the sweep center and the second mirror.

The gas absorption spectroscopy system according to clause 3 sweeps the first mirror, and the second mirror is controlled through feedback in response to a ring-down signal being obtained.

(Clause 4) In the gas absorption spectroscopy system according to any one of clauses 1 to 3, the driver may include a first actuator configured to move the first mirror and a second actuator configured to move the second mirror.

The gas absorption spectroscopy system according to clause 4 positionally moves two mirrors by an actuator that converts an electrical signal to physical motion.

(Clause 5) In the gas absorption spectroscopy system according to clause 4, the first and second actuators may each be a piezo element.

The gas absorption spectroscopy system according to clause 5 positionally moves two mirrors by a piezo element included in the actuator.

(Clause 6) In the gas absorption spectroscopy system according to clause 5, at least one of the first and second actuators may receive a voltage having a magnitude varying in a waveform with respect to time.

(Clause 7) In the gas absorption spectroscopy system according to clause 6, the waveform may be a triangular waveform.

(Clause 8) In the gas absorption spectroscopy system according to any one of clauses 1 to 7, the driver may sweep the first mirror with a width smaller than a length corresponding to a free spectral range (FSR), the free spectral range being an interval between two adjacent mode frequencies.

The gas absorption spectroscopy system according to clause 6 sweeps a mirror with a width smaller than a length corresponding to 1 FSR. The system can thus move the mirror fast.

(Clause 9) In the gas absorption spectroscopy system according to any one of clauses 1 to 8, the driver may sweep the first mirror at a frequency of 100 to 500 Hz.

The gas absorption spectroscopy system according to clause 8 sweeps a mirror at a frequency of 100 to 500 Hz.

(Clause 10) In the gas absorption spectroscopy system according to any one of clauses 1 to 9, the resonator may further include a third mirror, and a distance between the third and first mirrors may be equal to a distance between the first and second mirrors.

The gas absorption spectroscopy system according to clause 9 that comprises a ring-type optical resonator including three mirrors can measure a component contained in a gaseous sample with enhanced sensitivity without increasing a cost for introducing the system.

(Clause 11) In one aspect, a gas absorption spectroscopy method is a gas absorption spectroscopy method using a resonator for measuring a target component in a gas enclosed in a cell, the resonator including a first mirror and a second mirror disposed in the cell to reflect light therebetween, the gas absorption spectroscopy method comprising: irradiating the resonator with laser light emitted from a light source; moving at least one of the first and second mirrors about a sweep center to change a length between the first and second mirrors; obtaining a detection signal from the resonator; and, in response to the detection signal being obtained, adjusting a length between the sweep center and the second mirror to be equal to a length present between the first and second mirrors at a time when the detection signal is obtained.

The gas absorption spectroscopy system according to clause 10 that is a gas absorption spectroscopy system for measuring a component of a gas can measure a component contained in a gaseous sample with enhanced sensitivity without increasing a cost for introducing the system.

While embodiments of the present invention have been described, it should be understood that the embodiments disclosed herein are by way of illustration and example only and not to be taken by way of limitation in any respect. The scope of the present invention is defined by the terms of the claims and intended to encompass any modification that falls within the meaning and scope equivalent to the terms of the claims.

What is claimed is:

1. A gas absorption spectroscopy system that measures a target component in a gas enclosed in a cell, the gas absorption spectroscopy system comprising:
a resonator including a first mirror and a second mirror disposed in the cell to reflect light therebetween;
a light source configured to irradiate the resonator with laser light;
a driver configured to vary a length between the first and second mirrors;
a controller configured to control the driver; and
a detector configured to detect light extracted from the resonator and output to the controller a detection signal corresponding to the detected light, wherein
the driver is configured to:
move at least one of the first and second mirrors about a sweep center to change the length between the first and second mirrors; and
in response to the controller obtaining the detection signal, adjust a length between the sweep center and the second mirror to be equal to a length present between the first and second mirrors at a time when the detection signal is obtained.

2. The gas absorption spectroscopy system according to claim 1, wherein the detection signal is detected by the detector when a frequency of the laser light matches a resonant frequency of the resonator.

3. The gas absorption spectroscopy system according to claim 1, wherein
the second mirror is configured to be moveable, and
the driver is configured to move the second mirror to adjust the length between the sweep center and the second mirror.

4. The gas absorption spectroscopy system according to claim 1, wherein the driver includes:
a first actuator configured to move the first mirror; and
a second actuator configured to move the second mirror.

5. The gas absorption spectroscopy system according to claim 4, wherein the first and second actuators are each a piezo element.

6. The gas absorption spectroscopy system according to claim 5, wherein at least one of the first and second actuators receives a voltage having a magnitude varying in a waveform with respect to time.

7. The gas absorption spectroscopy system according to claim 6, wherein the waveform is a triangular waveform.

8. The gas absorption spectroscopy system according to claim 1, wherein the driver is configured to sweep the first mirror with a width smaller than a length corresponding to a free spectral range (FSR), the free spectral range being an interval between two adjacent mode frequencies.

9. The gas absorption spectroscopy system according to claim 1, wherein the driver is configured to sweep the first mirror at a frequency of 100 to 500 Hz.

10. The gas absorption spectroscopy system according to claim 1, wherein
the resonator further includes a third mirror, and
a distance between the third and first mirrors is equal to a distance between the first mirror and the second mirror.

11. A gas absorption spectroscopy method using a resonator for measuring a target component in a gas enclosed in a cell, the resonator including a first mirror and a second mirror disposed in the cell to reflect light therebetween, the gas absorption spectroscopy method comprising:
irradiating the resonator with laser light emitted from a light source;
moving at least one of the first and second mirrors about a sweep center to change a length between the first and second mirrors;
obtaining a detection signal from the resonator, and
in response to the detection signal being obtained, adjusting a length between the sweep center and the second mirror to be equal to a length present between the first and second mirrors at a time when the detection signal is obtained.
